(19) United States
(12) Patent Application Publication
(10) Pub. No.: US 2008/0006310 A1
(43) Pub. Date: Jan. 10, 2008

(54) Suction apparatus for textile-treatment water-jet beam

(75) Inventors: Ullrich Munstermann, Egelsbach (DE); Christoph Ackermann, Hackenheim (DE)

Correspondence Address: K.F. ROSS P.C., 5683 RIVERDALE AVENUE, SUITE 203 BOX 900, BRONX, NY, 10471-0900, US

(73) Assignee: Fleissner GmbH

(21) Appl. No.: 11/824,777

(22) Filed: Jul. 2, 2007

(30) Foreign Application Priority Data
Jun. 30, 2006 (DE) 102006030804.2

(51) Int. Cl. B05B 1/10

(52) U.S. Cl. 134/122 R

(57) ABSTRACT

A suction apparatus for an elongated water beam that extends transversely to and directs a liquid jet at a longitudinally passing textile web has a suction chamber extending transversely of the web adjacent the jet and having a perforated lower wall. Air is withdrawn from inside the chamber to aspirate spray from adjacent the jet through the perforated lower wall. A slot passage opens at a location between the liquid jet and the suction chamber. A blower supplies air at superatmospheric pressure to the slot passage and therethrough to the location between the liquid jet and the suction chamber.

### FIELD OF THE INVENTION

The present invention relates to a water-jet beam for treating a textile web. More particularly this invention concerns a suction apparatus or chamber for such a beam.

### BACKGROUND OF THE INVENTION

In the manufacture of a textile web workpiece, e.g. woven, knitted, or nonwoven textile including felts and fleeces made of staple fibers, continuous filaments or cellulose fibers and even having multiple layers it is standard to use a water-jet treatment. More specifically such textiles are treated by passing them over a support and directing high-pressure liquid jets at them from an overhead jet beam. A perforated suction surface provided below the jet beam aspirates the spray. A so-called suction chamber is provided between the jet beam and the workpiece to aspirate spray created by the process.

It is known from U.S. Pat. No. 6,457,335 to collect the liquid spraying against the water beam. Here the suction apparatus is located to the side of the water beam and extends along its entire length. A funnel-shaped slot formed at the edge of the water beam has a slot width of approximately 2 mm at its inner end. If a sufficiently strong vacuum is connected to the otherwise completely enclosed apparatus, all the droplets including any liquid droplets from the underside of the water beam can be aspirated safely from the goods being needled.

A water beam for the water needling of textiles is further known from WO 2001/040562 of Vuillaume that has a suction chamber attached to the water beam in an upper region and forming a groove adjacent the water jets, with a porous floor adjacent this groove. Thus spray is aspirated both through the groove and through the porous floor. Spray can only inadequately be removed with this apparatus. Furthermore, spray cannot be aspirated on the opposite side of the water jet.

### OBJECTS OF THE INVENTION

It is therefore an object of the present invention to provide an improved suction apparatus for a textile-treatment water-jet beam.

Another object is the provision of such an improved suction apparatus for textile-treatment water-jet beam that overcomes the above-given disadvantages, in particular that keeps the water jet focused on the textile web workpiece.

### SUMMARY OF THE INVENTION

A suction apparatus for an elongated water beam that extends transversely to and directs a liquid jet at a longitudinally passing textile web. The apparatus has according to the invention a suction chamber extending transversely of the web adjacent the jet and having a perforated lower wall, means for withdrawing air from inside the chamber and thereby aspirating spray from adjacent the jet through the perforated. lower wall, a slot passage open at a location between the liquid jet and the suction chamber, and blower .means for supplying air at superatmospheric pressure to the slot passage and therethrough to the location between the liquid jet and the suction chamber.

Thus according to the invention the water jet is completely freed of liquid droplets as the result of independently supplying dry air to the water jet in this manner. The air surrounding the water jet is therefore as dry as possible and essentially devoid of entrained droplets of liquid water or spray solution.

Use is made of the suction effect of the water jet running as high as 200 m/s. This water jet thus no longer draws in the moist surrounding air concentrated with liquid droplets, but instead draws in the dry air provided by the air supply device. Thus, deflection of the water jet by extremely fine water droplets in the air may be prevented. Use of the suction effect has the further advantage that air may be very economically supplied without complicated equipment.

It is also advantageous that the air supply device has an air-supply passage with a width of 1 to 15 mm, preferably 3 to 10 mm, and in particular 3 to 6 mm between an outer face of the water beam and a confronting outer face side of the suction chamber. In this particularly simple design of the air supply device the air supply passage is formed by an air gap between the water beam and the suction chamber. Thus, essentially no additional components are needed. However, the air supply passage may also be implemented by means of installed hoses, for example.

In one advantageous embodiment of the air supply device, the air may be supplied to the water beam in such a way that a blower is associated with the air supply device for producing a slight superatmospheric pressure. In this manner the dry air is actively supplied to the water jet, and the air supply to the water jet occurs not only due to the above-described suction effect, but also as a result of a slight positive pressure inside the air supply passage.

According to a further feature of the invention, it is advantageous that the outlet opening in the air supply device extends approximately over the entire length of the water beam. This ensures in a simple manner that the water jet is supplied with dry air over the entire length of the water beam, and therefore is not influenced by fine water droplets or liquid droplets.

In a further embodiment of the invention the outlet opening in the air supply device is oriented in such a way that the air stream strikes the water jet exiting from the water beam approximately perpendicularly. The exiting water jet is thus focused in a simple manner, and water spray is guided in the direction of the water jet. It is also advantageous when the air supply device, i.e. the air gap, is provided at least partially. between the water beam and the outlet opening in the suction chamber. This way air is guided along the outer side of the water beam and in the vicinity of a lower side of the water beam runs parallel thereto. The exiting water jet is focused with the assistance of the dry air stream exiting from the air supply device in the vicinity of the underside of the water beam. The introduced air stream is thus protected from water spray until exiting, since the air supply passage is delimited on the underside by the suction chamber.

According to one refinement of the invention, pairs of suction chambers and/or air supply devices may be symmetrically positioned on both sides of the water beam and/or the water jet. Water spray reflected from the fabric may thus be aspirated in the direction of travel of the fabric after the water jet strikes, or if necessary, also upstream from the water jet. Likewise, dry air may be independently supplied via the air supply device either upstream or downstream from the water jet. In this manner the suction chamber and the air supply device may be situated independently of one another in any given combination.

It is also advantageous when the perforated suction surface is inclined at an angle, and extends from an upper region in the vicinity of the water beam and/or a drip edge to a lower region of the suction chamber. This ensures in a simple and economical manner that the water beam is essentially free of droplets, and also ensures that the water spray is completely aspirated on both sides of the water jet, thereby preventing droplets from falling on the fabric, knitted fabric web, or nonwoven fabric and possibly contaminating or damaging same. The deflection of the water spray is particularly effective, since at the inclined suction surface of a suction chamber water droplets flow by gravity toward the lower region of the suction surface, and are thus removed from the water jet. For this purpose the region of the suction chamber facing the water beam may also be designed without a drip edge.

To this end it is advantageous if the perforated suction surface has openings with different sizes of cross-sectional areas. This ensures a uniform suction pressure over the entire suction surface of the suction device. The cross-sectional areas of the openings can become increasingly larger from the drip edge downward. The cross-sectional areas of the openings can become increasingly larger starting from the drip edge either in a continuous manner or in uniform steps. The distances between the individual openings are the same or different.

An angle defined by a tangent of a screen roller over which the workpiece web passes and the perforated suction surface is between 5° and 25°, in particular between 6° and 15°, and the openings in the suction surface at the inner side facing the water jet form an open surface or flow cross section of approximately 3% to 8%, preferably 5%, and at the outer side form a surface of approximately 10% to 25%, preferably 20%, of the total surface of the lower wall. In this manner a stronger air flow is obtained on the outer side of the suction surface than on the inner side. The water droplets that migrate to the lower, and thus the outer, region of the suction surface due to gravity are then ultimately aspirated through the large openings inside the suction chamber.

To this end, it is also advantageous that the openings in the perforated suction surface at the inner side facing the water jet are preferably designed as parallel slots having a length between 1 mm and 10 mm and a width between 0.1 mm and 3 mm, and that the openings provided at the outer side of the perforated suction surface preferably have an angular design with a length between 1 mm and 10 mm and a width between 0.1 mm and 3 mm.

It is particularly advantageous when the openings have different shapes of cross-sectional areas, and have oval, polygonal, angular, or oblong slotted designs. Such a configuration and shape of the openings ensures that in their migration along the surface in the direction of the lower region of the suction surface, the droplets are forced to pass through the openings and cannot easily bypass same openings in the perforated suction surface which have an angular design in the region with a relatively large open surface are particularly effective.

With the present invention an air displacement element is positioned in the suction chamber in such a way that a uniform suction effect is ensured over the entire width and/or length of the perforated suction surface, since the suction occurs on one side. Air flow inside the suction chamber may be finely adjusted, if necessary, by appropriately positioning of the air displacement element. Particular flexibility is achieved when the air displacement element is installed with variable height and inclination.

It is advantageous if the air-displacement body is located above the perforated suction surface, and in particular above the portion of the suction surface having a relatively large open portion, and if it constricts the perforated suction surface such that a maximum air current of, for example, 2 m/s is achieved on the outside of the perforated suction surface.

In a further embodiment of the invention, it is advantageous that the air-displacement body extends substantially across the entire width and/or length of the suction chamber and that the air-displacement body is a substantially rectangular element, particularly a box that extends at an angle in the direction of the suction chamber.

It is also advantageous when the air-displacement body has an lower surface that forms an angle ranging between 1° and 30°, particularly between 1° and 5°, in the longitudinal direction of the suction chamber with the lower wall thereof, the gap between the air-displacement body and the perforated suction surfaces becoming narrower away from the outlet port through which air is sucked from the chamber.

The air-displacement body according to the invention ends short of one end lateral wall of the chamber having the suction outlet. Since the gap between the air-displacement body and the perforated suction surface becomes narrower in the direction of the suction device, a varying suction effect can be prevented by one-ended suction.

### BRIEF DESCRIPTION OF THE DRAWING

The above and other objects, features, and advantages will become more readily apparent from the following description, reference being made to the accompanying drawing in which:

FIG. 1 is a largely diagrammatic end view of the system of this invention;

FIG. 2 is a sectional end view of the system of the present invention;

FIG. 3 is a section taken along line III-III of FIG. 2; and

FIG. 4 is a bottom view of the floor of the suction chamber.

### SPECIFIC DESCRIPTION

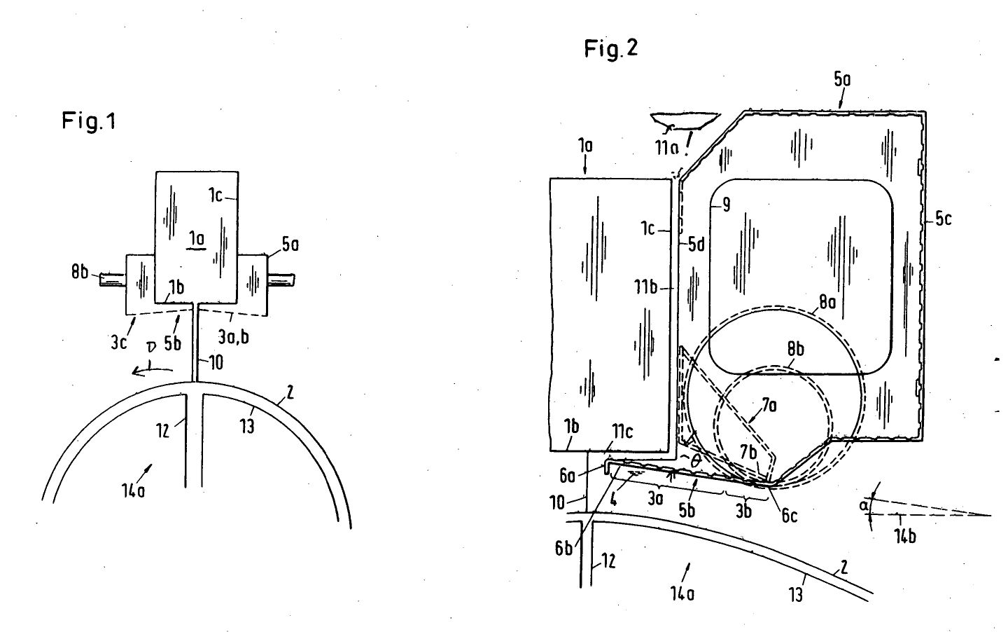

As seen in FIG. 1, water beam 1a emits a water jet 10 from a transversely extending row of unillustrated nozzle orifices and impinges upon a textile workpiece 2 that can be woven, knitted, or nonwoven and that is guided over a cylindrical support drum 13 of a perforated drum or perforated roller 14a. Water is mostly removed by means of a water removal passage 12 of the perforated roller 14a that opens centrally upward in line with the jet 10.

Adjacent the water beam 1a is a suction apparatus or suction chamber 5a which has a sloping perforated suction surface 3a, provided with openings 3c on its lower wall 5b so that the spray formed when the water jet 10 impinges on the textile workpiece 2 is pulled to the lower wall of the suction chamber 5b and is then completely sucked from the suction chamber 5a. Water droplets thus do not collect on the lower face of the water beam 1a and no longer drip onto the workpiece 2.

In this embodiment two such suction chambers 5a are arranged symmetrically on both sides of the water beam 1a, upstream and downstream relative to a workpiece travel direction D. A vacuum is created in the suction chamber 5a by a pump 15 (FIG. 9) connected to the suction chamber 5a via a suction hose 8b.

FIG. 2 shows a further embodiment of the suction chamber 5a for the water beam 1a for jet treatment of a textile workpiece 2. It has perforated suction regions 3a and 3b on the lower wall 5b of the suction chamber 5a for the aspiration of spray. The perforated suction regions 3a and 3b are provided on an incline so that they extends from an upper edge 6b close to the water beam 1a and/or a drip edge 6a to a lower edge 6c of the suction chamber 5a remote from the jets 10. The first region 3a of the perforated suction surface has a relatively small open area, that is ratio of area of openings to area of closed portions between the openings, while the second section 3b of the perforated suction surface has a relatively large open/closed ratio, that is a greater portion of its overall surface area taken up by suction openings. In an embodiment not shown in the drawings the suction chamber can also be formed without the drip edge 6a.

The openings 3c in the perforated suction surface have a smaller area or flow cross-section in the region 3a than the openings 3c in the region 3b. In this way, an approximately uniform suction pressure is generated on the inner upper side of the suction surface 3a or 3b so that spray impinging upon the textile workpiece 2 can easily be removed by suction. Water droplets flowing downward along the lower face of the floor 5b as a result of gravity can be sucked completely into the suction chamber 5a through the larger openings 3c in the lower area of the suction surface 6c.

The distance between the individual openings 3c can be the same or different. The cross-sectional areas of the openings 3c increase moving away from the drip edge 6a toward the suction chamber 5a or an outer wall 5c of the suction chamber 5a remote from the water beam 1a. To achieve this effect the cross-sectional areas of the openings 3c beginning from the drip edge 6a can become increasingly larger continuously or in uniform steps.

As can be seen from the second embodiment in FIG. 2, a horizontal tangent 14b to the cylindrical outer surface of the upper part of the perforated roller 14a forms an angle α with the lower surface of the suction surface 3a and 3b. The angle α can be between 5° and 25°, but preferably is between 6° and 15°. The openings 3c of the inner region 3a closer to the water jet 10 of the water beam 1a account for an open area of about 3% to 8%, preferably 5% and on the outer region 3b then form an open area of about 10% to 25%, preferably exactly or about 20%. According to FIG. 2, the suction chamber 5a is located on the right-hand or upstream side of the water beam 1a, and can be embodied as an approximately rectangular box to receive spray 4.

According to FIG. 2, the water beam 1a and the suction chamber 5a have an associated air supply with a blower 11a whose output is connected to an air-supply passage 11b which opens horizontally near the lower wall 1b of the water beam 1a at an outlet opening 11c near the water jet 10. The air-supply passage 11b is formed by a vertical outer side wall of the water beam 1c and a vertical outer side wall 5d of the suction chamber 5a. For this purpose the air-supply passage 11b runs approximately parallel to the outer side of the water beam 1a and the lower wall 1b of the water beam 1a. The drip edge 6a of the suction chamber 5a is near the outlet opening 11c of the air-supply passage 11b. Only very fine water droplets can form at the drip edge 6a, and they cannot cause any further damage when they fall downward.

Dry air passing through the air-supply passage 11b of the air supply apparatus 11a to the water jet 10 has the advantage that it does not influence the movement of the water jet 10. The water jet 10 is thus not influenced by very fine water droplets or mist and can in particular be projected onto the textile workpiece 2 in a focused manner. In this embodiment according to FIG. 2, dry air is pulled through the air-supply passage 11b by the suction effect created by the water jet 10. It is also possible for dry air to be actively supplied to the water jet 10 by means of the blower 11a, so that this blower is optional so long as some means is provided for moving air through the passage.

In FIG. 2 the air supply apparatus 11a and the suction chamber 5a are only located in the right-hand side of the water beam 1a. However, as suggested by FIG. 1, the suction chamber 5a can be arranged symmetrically on both sides of the water beam 1a. The air supply apparatus 11a can also be arranged symmetrically on both sides of the water beam 1a.

The cross-sectional surface of the air feed device 11a or air feed passage 11b ranges between 3 and 15 mm, preferably between 5 and 10 mm, particularly between 7 and 8 mm.

The width of the air-supply passage 11b is between 3 and 15 mm, preferably between 5 and 10 mm, especially between 7 and 8 mm. In this embodiment, the air-supply passage 11b of the air supply apparatus 11a is of a width of 1 to 15 mm, preferably. 3 to 10 mm, and especially 3 and 6 mm between an outer face of the water beam 1c and the confronting outer face of the wall 5d of the suction chamber 5a facing the water beam 1a. In an embodiment not shown in the drawings, the air-supply passage 11b can also be formed by hoses or similar air supply apparatus.

The outlet opening 11c extends approximately over the entire length of the water beam 1a. The outlet opening 11c is further aligned so that the air jet emerging from it impinges approximately horizontally and perpendicularly on the vertical water jet 10 emerging from the water beam 1a.

According to FIG. 4, the openings 3c of the perforated suction surface on the side 3a facing the water jet 10 can be embodied as elongated approximately parallel slots having a length between 1 mm and 10 mm and a width A between 0.1 mm and 3 mm. It is furthermore possible that the slots provided on the outer side 3b of the perforated suction surface are preferably embodied as angular with a length between 1 mm and 10 mm and a width B between 0.1 mm and 3 mm. Depending on the embodiment, the slots can also have a linear or a corrugated profile, or even be chevron shaped. All these configurational variants of the openings 3c have the purpose of receiving as efficiently as possible that water droplets of the spray 4 move along the perforated suction surface. They are also oriented to prevent droplets of spray 4 from running between the openings 3c.

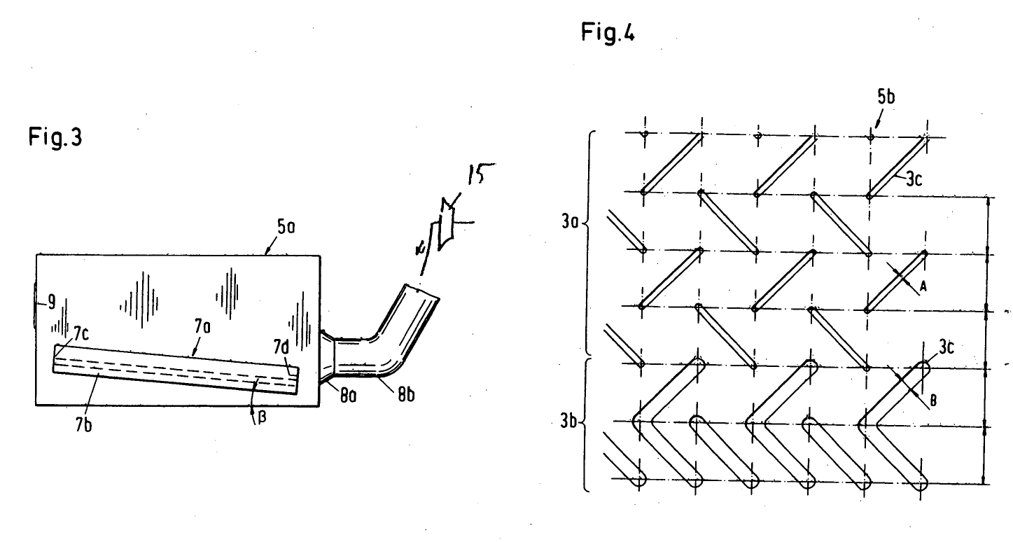

According to a further embodiment as shown in FIGS. 2 and 3, an air-displacement body 7a can be provided in the suction chamber 5a, which can have different shapes. According to FIGS. 2 and 3, the air-displacement body 7a is hollow and is defined by two parallel end walls 7c and 7d. In the area of the suction regions 3a and 3b, a lower wall 7b of the displacement body 7a runs approximately parallel to the inner surface of the perforated suction regions 3a and 3b. Between the lower wall 7b of the displacement body 7a and the inner surface of the suction surface 3a and 3b is a small gap between 2 mm and 10 mm wide that ensures that a uniform suction pressure is achieved over the entire suction surface. The air-displacement body 7a is located above the perforated suction regions 3a and 3b, especially above the suction surface provided with a relatively large open area 3b so that the perforated suction regions 3a and 3b are constricted so that a maximum air flow of 2 m/s for example is achieved at the outer side of the perforated suction surface 3b.

The air-displacement body 7a advantageously extends over the entire length of the suction chamber 5a. In order to achieve the greatest possible flexibility in adjusting the air flows inside the suction chamber 5a, in a further advantageous embodiment not shown in the drawings the air-displacement body 7a can be mounted so that its height and inclination can be varied.

As can be seen from FIG. 2, the lower wall 7b of the displacement body 7a extends in the same direction as the suction surface 3a and 3b and forms an angle θ between 5° and 30° therewith. As can be further seen from FIG. 3, the air-displacement body 7a can also enclose an angle β with its lower wall 7b toward the inner surface of the perforated suction regions 3a and 3b, this angle being between 1° and 30° or between 1° and 5°, the gap between the air-displacement body 7a and the perforated suction regions 3a and 3b becoming narrower toward a suction outlet fitting 8a. Located at one end of the suction chamber 5a is the suction apparatus consisting of the fitting or connection 8a and the suction hose 8b, via which the spray received from the suction chamber 5a is removed and the vacuum therein is produced by the blower 15. The interior of the suction chamber 5a is accessible via an access door 9.

As can be seen from FIG. 3, the air-displacement body 7a advantageously ends with its lower end adjacent the connection for the suction apparatus 8a.

I claim:

1. A suction apparatus for an elongated water beam that extends transversely to and directs a liquid jet at a longitudinally passing textile web, the apparatus comprising:
a suction chamber extending transversely of the web adjacent the jet and having a perforated lower wall;
means for withdrawing air from inside the chamber and thereby aspirating spray from adjacent the jet through the perforated lower wall;
a slot passage open at a location between the liquid jet and the suction chamber; and
blower means for supplying air at superatmospheric pressure to the slot passage and therethrough to the location between the liquid jet and the suction chamber.

2. The suction apparatus defined in claim 1 wherein the passage is formed by a wall of the water beam and a wall of the suction chamber and has a width between 1 mm and 15 mm.

3. The suction apparatus defined in claim 1 wherein the passage extends a full length of the water beam.

4. The suction apparatus defined in claim 1 wherein the passage has a slot outlet opening generally perpendicularly to the liquid jet.

5. The suction apparatus defined in claim 4 wherein the passage is generally L-shaped, with a vertical leg between walls of the chamber and water beam and a horizontal leg underneath the water beam and forming the outlet.

6. The suction apparatus defined in claim 1 wherein there are two such suction chambers and passages flanking the beam.

7. The suction apparatus defined in claim 1 wherein the perforated lower wall slopes downward away from an upper region close to the water beam and a lower region remote therefrom.

8. The suction apparatus defined in claim 7 wherein the perforated lower wall is formed with an array of openings of different cross-sectional area.

9. The suction apparatus defined in claim 8 wherein the cross-sectional areas of the openings increase away from the liquid jet.

10. The suction apparatus defined in claim 9 wherein the cross-sectional areas of the openings increase continuously away from the liquid jet.

11. The suction apparatus defined in claim 9 wherein the cross-sectional areas of the openings increase in steps from the liquid jet.

12. The suction apparatus defined in claim 8 wherein a spacing between the openings varies away from the liquid jet.

13. The suction apparatus defined in claim 8 wherein the lower wall forms with a horizontal plane tangent to the web where it is impinged by the jet an angle between 5° and 25°.

14. The suction apparatus defined in claim 8 wherein the perforated lower wall is formed with an array of openings having a total surface area varying between about 25% at the upper region and 3% at the lower region.

15. The suction apparatus defined in claim 1 wherein the perforated lower wall has openings between 0.1 mm and 3 mm wide and between 1 mm and 10 mm long.

16. The suction apparatus defined in claim 1, further comprising
means including an air-displacement body inside the suction chamber oriented for generally uniform suction across the perforated lower wall.

17. The suction apparatus defined in claim 16 wherein the air-displacement body is spacedly juxtaposed above the lower wall of the chamber so as to produce a maximum air flow of about 2 m/s on a lower face of the lower wall.

18. The suction apparatus defined in claim 16 wherein the air-displacement body has a lower surface extending at an acute angle to the lower wall.

19. The suction apparatus defined in claim 16 wherein the air-displacement body extends over an entire length of the suction chamber.

20. The suction apparatus defined in claim 16 wherein air is drawn from a longitudinal vent end of the suction chamber and the lower surface of the air-displacement body and the perforated lower wall converge away from the vent end.

21. The suction apparatus defined in claim 20 wherein the lower surface and lower wall form an angle between 1° and 30°.

22. The suction apparatus defined in claim 20 wherein the air-displacement body ends at a spacing from the vent end.
